(19) United States
(12) Patent Application Publication
(10) Pub. No.: US 2011/0187903 A1
(43) Pub. Date: Aug. 4, 2011

(54) DIGITAL PHOTOGRAPHING APPARATUS FOR CORRECTING IMAGE DISTORTION AND IMAGE DISTORTION CORRECTING METHOD THEREOF

(75) Inventors: Jae-ho Kim, Seoul (KR); Kyu-yul Choi, Yongin-si (KR)

(73) Assignee: Samsung Electronics Co., Ltd., Suwon-si (KR)

(21) Appl. No.: 12/880,330

(22) Filed: Sep. 13, 2010

(30) Foreign Application Priority Data
Feb. 2, 2010 (KR) 10-2010-0009667

(51) Int. Cl. H04N 5/217

(52) U.S. Cl. 348/241; 348/E05.078

(57) ABSTRACT

A digital photographing apparatus for correcting image distortion performs an image distortion correcting method. The image distortion correcting method includes receiving an image signal through a lens, extracting image data having distortion in a block form from the received image signal, correcting the distortion by dividing the extracted image data, and generating and displaying an output image by combining the corrected image data.

### CROSS-REFERENCE TO RELATED PATENT APPLICATION

This application claims the priority benefit of Korean Patent Application No. 10-2010-0009667, filed on Feb. 2, 2010, in the Korean Intellectual Property Office, the disclosure of which is incorporated herein in its entirety by reference.

### BACKGROUND

1. Field of the Invention

Embodiments relate to a digital photographing apparatus for correcting image distortion caused by a lens and an image distortion correcting method thereof.

2. Description of the Related Art

A user may use a variety of lenses to obtain an image of a wide area. For example, a fish-eye lens or a wide lens may be used representatively and, if photographing is performed using these lenses, an image with severe barrel-like distortion may be intentionally obtained. This image may need to be expressed with a corrected image that a user wants through distortion correction. Although there are various suggested methods of correcting the image, a user wants to correct image distortion fast and obtain a corrected image with less distortion.

### SUMMARY

An embodiment includes a digital photographing apparatus for performing an image distortion correcting operation at a fast speed by improving a method of extracting image data from an input image, and a method of correcting image distortion thereof.

According to an embodiment, a method of correcting image distortion in a digital photographing apparatus includes: receiving an image signal through a lens; extracting image data having distortion in a block form from the received image signal; correcting the distortion by dividing the extracted image data; and generating and displaying an output image by combining the corrected image data.

The image data may have a block form including a tile size X in a row direction and a line buffer size Y in a column direction.

The image data may determine starting address coordinate values of a portion having the distortion, the portion having the distortion determined as a block comprising the tile size X in the row direction and the line buffer size Y in the column direction through the starting address coordinate values.

When the tile size X of the image data is 64 pixels, the line buffer size Y may be 12 lines.

When the tile size X of the image data is 128 pixels, the line buffer size Y may be 21 lines.

When the tile size X of the image data is 256 pixels, the line buffer size Y may be 38 lines.

When the tile size X of the image data is 512 pixels, the line buffer size Y may be 70 lines.

The method may further include: storing the image signal from the lens in a first memory; and extracting the image data in a block form and temporarily storing the extracted image data in a second memory.

The method may further include correcting distortion by dividing the image data stored in the second memory into more than one sub block.

According to another embodiment, a method of correcting image distortion in a digital photographing apparatus includes: receiving an image signal through a lens; extracting first image data of a portion having distortion in a block form from the image signal and loading the extracted first image data into a temporary memory; extracting second image data adjacent to the first image data in a block form and loading the extracted second image data into a temporary memory while the distortion of the first image data is corrected by dividing the loaded first image data; correcting distortion of the second image data by dividing the second image data; and generating and displaying an output image by combining the corrected image data.

The image data may have a block form including a tile size X in a row direction and a line buffer size Y in a column direction.

The method may further include correcting the distortion by dividing the loaded image data into more than one sub block.

The method may further include storing the image signal from the lens in a memory.

According to another embodiment, a digital photographing apparatus includes: a lens that receives an image signal; an image signal processor that extracts image data of a portion having distortion in a block form from the image signal, loads the extracted image data in a temporary memory, corrects the distortion by dividing the loaded image data, and generates an output image by combining the corrected image data; and a display unit that displays the output image.

The image signal processor may include: an image data extracting unit that extracts image data of a portion having distortion in a block form and loads the extracted image data into a temporary memory; a distortion correcting unit that corrects the distortion by dividing the loaded image data; and an output image generating unit that generates an output image by combining the corrected image data.

The image data has a block form that may include a tile size X in a row direction and a line buffer size Y in a column direction.

### BRIEF DESCRIPTION OF THE DRAWINGS

The above and other features and advantages will become more apparent by describing in detail exemplary embodiments with reference to the attached drawings in which:

FIG. 1 is a block diagram of a digital photographing apparatus according to an embodiment;

FIG. 2 is a block diagram illustrating an image signal processor of FIG. 1;

FIG. 3 is an exemplary view of a subject;

FIG. 4 is an exemplary view of an image signal obtained by transmitting light from the subject of FIG. 3 through a lens;

FIG. 5A is an exemplary view of an image data block B;

FIGS. 5B and 5C are views illustrating a distortion correcting operation of an exemplary distortion correction unit;

FIG. 6 is a view illustrating a method of extracting image data from an input image according to an embodiment;

FIG. 7 is a view illustrating a method of correcting image distortion, according to an embodiment; and

FIG. 8 is a flowchart illustrating a method of correcting image distortion, according to an embodiment.

### DETAILED DESCRIPTION

Hereinafter, embodiments will be described in detail with reference to the attached drawings.

However, this does not limit the invention within specific embodiments and it should be understood that the invention covers all the modifications, equivalents, and replacements within the idea and technical scope of the invention. Moreover, detailed descriptions related to well-known functions or configurations may be omitted in order not to unnecessarily obscure subject matters of the invention.

It will be understood that although the terms of first and second are used herein to describe various elements, these elements should not be limited by these terms. Terms are only used to distinguish one component from other components.

In the following description, the technical terms are used only for explaining a specific exemplary embodiment while not limiting the invention. The terms of a singular form may include plural forms unless referred to the contrary. The meaning of ‘comprises’ and/or ‘comprising’ specifies a property, a region, a fixed number, a step, a process, an element and/or a component but does not exclude other properties, regions, fixed numbers, steps, processes, elements and/or components.

Hereinafter, embodiments are described in more detail with reference to the accompanying drawings and, while describing the accompanying drawings, like reference numerals in the drawings denote like elements. Therefore, overlapping description will be omitted.

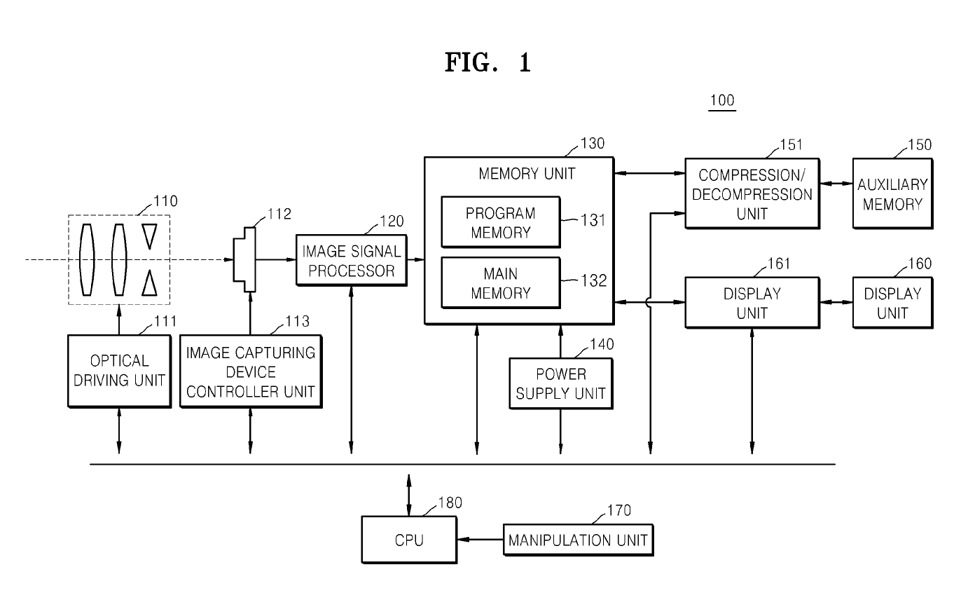

FIG. 1 is a block diagram of a digital photographing apparatus 100 according to an embodiment.

FIG. 1 illustrates a digital camera as a kind of the digital photographing apparatus 100. Embodiments are not limited to the digital camera of FIG. 1, and may be applied to a digital single-lens reflex (DSLR) camera, a video camera, a camera phone, an MPEG-3 Audio player (MP3), a personal digital assistant (PDA), and a personal multimedia player (PMP). This also applies to the following modified embodiments.

An optical unit 110 may include a lens unit that collects an optical signal, an aperture, and a shutter that adjusts a quantity of the optical signal.

The lens unit may include a zoom lens for narrowing or widening an angle according to a focal length and a focus lens that focuses on a subject. The one or more lenses of the lens unit may be individual lenses, separate from each other, or include groups of a plurality of lenses. According to another embodiment, the optical unit 110 may include a fish-eye lens. The fish-eye lens generates a barrel-like distortion intentionally so that uniform brightness and sharpness are maintained over an entire angle range of more than 180°. If a picture is taken with a fish-eye lens, an image of a subject corresponding to the center of the lens is expressed as being extremely large and an image of a subject corresponding to the lens periphery is expressed as being extremely small. That is, the fish-eye lens facilitates obtaining a wide image but the obtained image has intense distortion. In addition, the optical unit 110 of the present invention is not limited to this and may include a wide-angle lens having a wide angle and distortion. However, the distortion is not limited to this and may also occur in a case of a general lens because there is curvature on the surface of the lens. According to an embodiment, a technique for correcting distortion of an input image caused by various kinds of lenses is suggested.

An optical driving unit 111 for driving the optical unit 110 may change a position of a lens and drive an opening/closing in order to execute operations such as Auto-Focus, Auto White Balance, aperture adjustment, zoom, and focus change. The optical driving unit 111 may drive the optical unit 110 by receiving a control signal from a central processing unit (CPU) 180.

An image capturing device 112 includes a photoelectric conversion device that receives an optical signal input by the optical unit 110 and converts the received optical signal into an image signal. A Charge Coupled Device (CCD) sensor array and a Complementary Metal Oxide Semiconductor (CMOS) sensor array may be used as the photoelectric conversion device of the image capturing device 112. The image capturing device 112 may be controlled by an image capturing device controller unit 113 and an image signal output from the image capturing device 112 may be input to an image signal processor 120.

The image signal processor 120 may convert an image signal, if the image signal is an analog signal input from the image capturing device 112, into a digital signal and may perform various image processing operations on the image signal. Specifically, the image signal processor 120 may perform signal processing operations such as Auto White Balance, Auto Exposure, and Gamma Correction to convert an image signal to image data fit for human vision in order to improve image quality so that an improved image signal can be output. Moreover, the image signal processor 120 may perform image processing such as color filter array interpolation, color matrix calculation, color correction, and color enhancement. The image signal processor 120 may correct distortion by extracting image data in a block form about a portion (where distortion occurs by a lens) from an input image signal and then generates an output image before outputting the output image to the display unit 160. An image signal, which is diversely processed by the image signal processor 120, may be temporarily stored in a memory unit 130 or an auxiliary memory 150.

The memory unit 130 may include a program memory 131 where a program related to an operation of the digital photographing apparatus 100 is stored regardless of power supply and a main memory 132 where a captured image signal is temporarily stored while power is supplied.

The program memory 131 may store an operating system (OS) and an application program for an operation of the digital photographing apparatus 100. The program memory 131 may use an Electrically Erasable Programmable Read Only Memory (EEPROM), a flash memory, or a read only memory (ROM).

The main memory 132 may temporarily store an image signal output from the image signal processor 120 or the auxiliary memory 150.

A power supply unit 140 may be directly connected to the memory unit 130 and may supply power to operate the digital photographing apparatus 100. Accordingly, for fast booting of the digital photographing apparatus 100, code stored in the program memory 131 in advance may be copied to the main memory 132 and changed into an executable code. In a case of rebooting of the digital photographing apparatus 100, data stored in the main memory 132 may be read at a fast speed.

An image signal stored in the main memory 132 may be output to a display driving unit 161 and be converted into an analog signal. Then, the analog signal may be displayed on a display unit 160 and viewed by a user as a predetermined image. The display unit 160 may continuously display an image signal obtained by the image capturing device 112 during an image capturing mode and also serve as a view finder to determine a shooting range. Various display devices such as a liquid crystal display (LCD), an organic light emitting diode (OLED) display, and an electronic display device (EDD) may be used as the display unit 160.

An operation for recording an image signal output from the image signal processor 120 in the auxiliary memory 150 may be described as follows.

When an image signal is temporarily stored in the memory unit 130, various information, including shooting data, an exposure, a shutter speed, and a sensitivity, about the image signal is also stored. Then, the image signal and information stored in the memory unit 130 are output to a compression/decompression unit 151. The compression/decompression unit 151 generates an image file using a compression circuit for performing compression to obtain an optimal format for storing (i.e., encoding processing such as joint photographic coding experts group (JPEG)), and then the image file is stored in the auxiliary memory 150.

Besides a fixed semiconductor memory such as an external flash memory or a semiconductor memory such as a card type flash memory detachable from a device in a card form or a stick form, a magnetic memory medium such as a hard disk or a floppy disk may be used as the auxiliary memory 150.

In regards to an operation for playing an image file stored in the auxiliary memory 150, an image file compressed and stored in the auxiliary memory 150 is output to the compression/decompression unit 151 and then, an image signal is extracted by performing decompression processing (i.e., decoding processing) in the decompression circuit. Then, the image signal is output to the memory unit 130. The image signal is temporarily stored in the memory unit 130 and then a predetermined image is displayed on the display unit 160 through the display driving unit 161.

In addition, the digital photographing apparatus 100 includes a manipulation unit 170 that receives an external signal such as a user input. The manipulation unit 170 may include a shutter release button for opening and closing a shutter to expose the image capturing device 112 to light during a predetermined time, a power button for supplying power, a wide-zoom button for broadening or narrowing an angle according to an input, and various functional buttons for character input, mode selection of a shooting mode and a playing mode, white balance setting function selection, and exposure setting function selection.

The CPU 180 performs operations according to the OS and application program stored in the memory unit 130, temporarily stores the operation result, and drives the digital photographing apparatus 100 by controlling the above corresponding components according to the operation result.

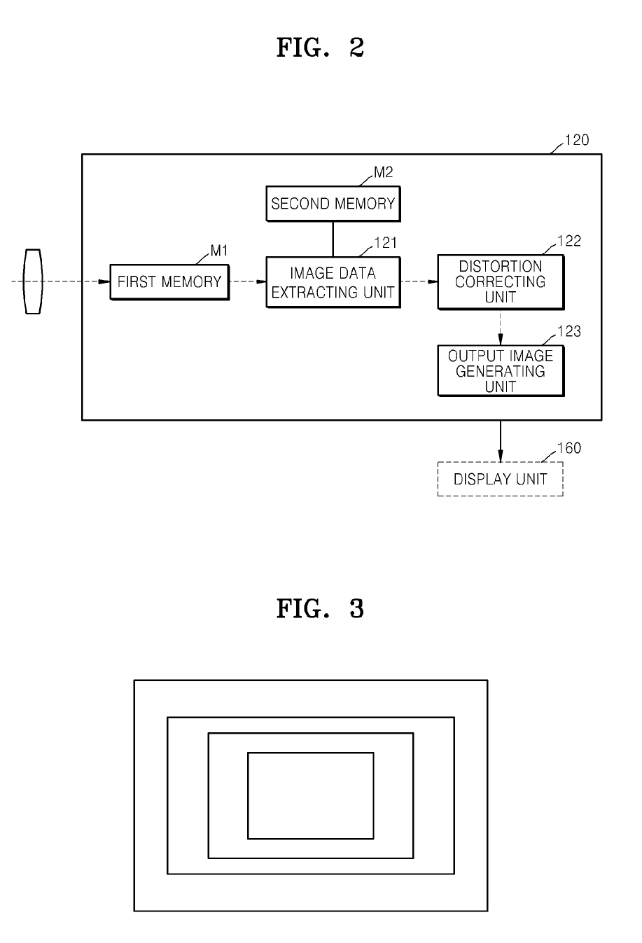

FIG. 2 is a block diagram illustrating the image signal processor 120 of FIG. 1.

Referring to FIG. 2, the image signal processor 120 includes an image data extracting unit 121, a distortion correcting unit 122, and an output image generating unit 123.

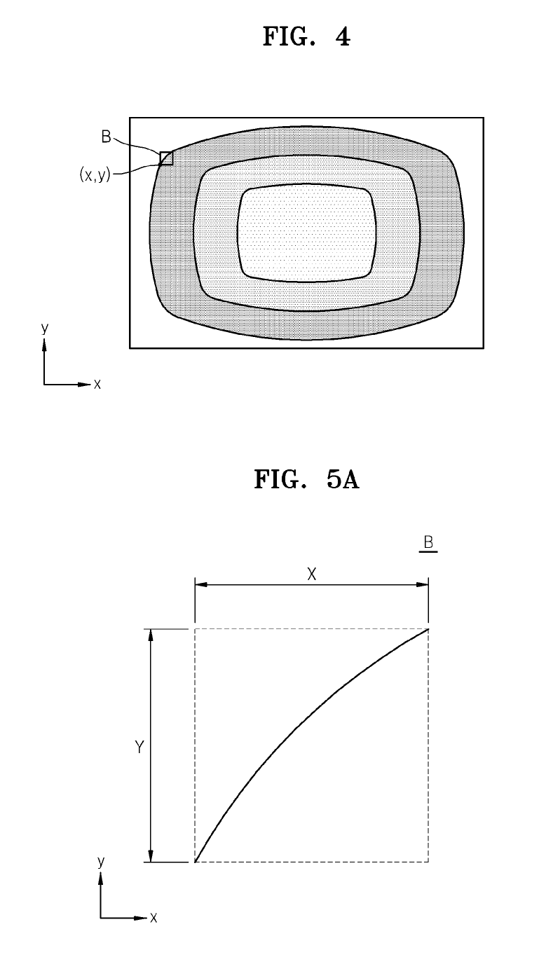

First, an operation for capturing an image of a subject by the optical unit 110 will be described. FIG. 3 is an exemplary view of the subject. FIG. 4 is an exemplary view of an image signal obtained by transmitting light from the subject of FIG. 3 through a lens. Referring to FIGS. 3 and 4, the image signal obtained through the lens transmission has a less distortion portion at the center of the lens than outer portions and has a radial distortion phenomenon where an image bends as it approaches toward the outer portion of the lens. The image signal of FIG. 4, which is input through the lens, is stored in a first memory M1. The first memory M1 may be included in the image signal processor 120. However, the invention is not limited thereto and may be realized with an additional module.

The image data extracting unit 121 extracts image data of a portion with distortion in a block form among image signals input through the lens. Specifically, the image data extracting unit 121 extracts a portion of the image data from the image signal stored in the first memory M1.

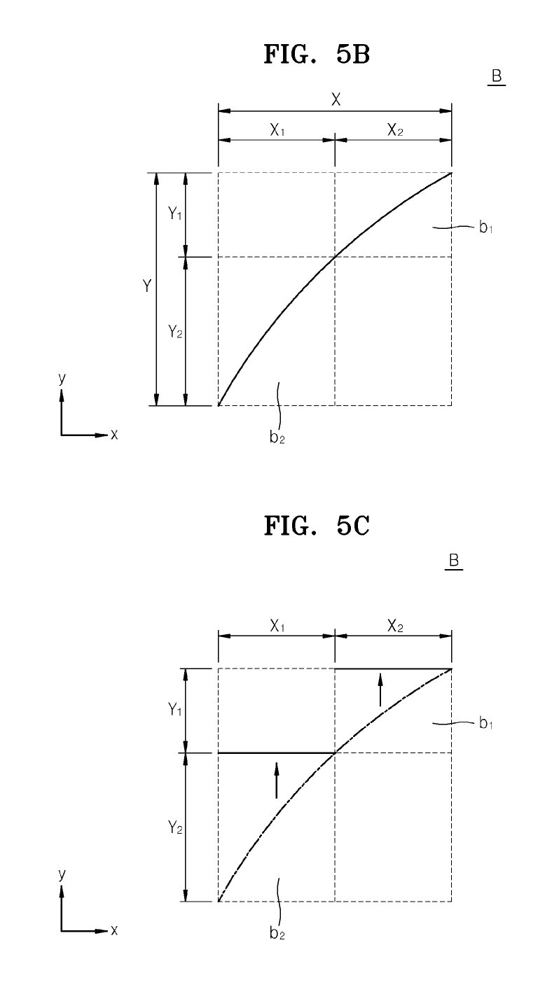

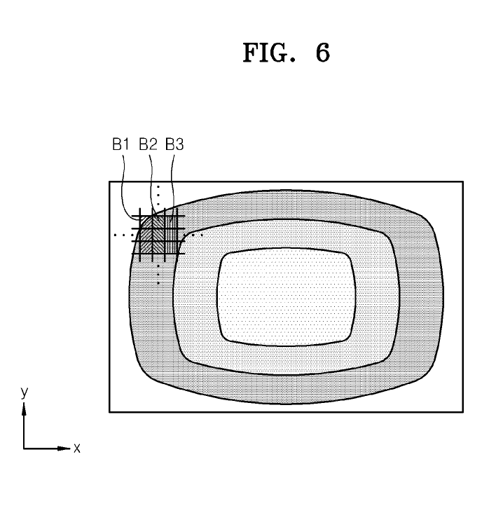

In more detail, the image data extracting unit 121 determines a starting address coordinate values x and y of a portion where distortion of an image signal occurs. Then, a tile size X is determined in a row direction (an x-axis direction) from the starting address coordinate values x and y. In addition, a line buffer size Y is determined in a column direction (a y-axis direction) from the starting address coordinate values x and y. FIG. 5A is an exemplary view of an image data block B. The image data extracting unit 121 extracts image data from an image data block B of an X×Y size and stores the extracted image data in a second memory M2 shown in FIG. 2. Here, the second memory M2 may be a temporal memory or may be a line buffer memory. Moreover, a combination of the tile size X and the line buffer size Y for determining the image data block B is shown in Table 1 below. The size of the second memory M2 is determined experimentally with data or by using mathematical algorithms. When the image data block B for a combination of the tile size X and the line buffer size Y is extracted like Table 1, the maximum image data loading speed with respect to the capacity of the second memory M2 is realized.

TABLE 1

| TILE SIZE X | LINE BUFFER SIZE Y |
|---|---|
| (NUMBER OF PIXELS) | (NUMBER OF LINES) |
| 64 | 12 |
| 128 | 21 |
| 256 | 38 |
| 512 | 70 |

According to an embodiment, image data for performing distortion correction is extracted with a block form of an X×Y size and is temporarily stored in a memory. Then, the image distortion is corrected. In a typical method of the conventional art, image data is not extracted with a block form and image data of a row in an input image is sequentially extracted and then distortion correction is performed on the image data. Thus, distortion is corrected at a slow speed.

However, according to an embodiment, image data in a block form, which is only needed for distortion correction, is extracted and then temporarily stored in a memory. Then, distortion correction is performed. Thus, data loading and distortion correction can be performed at a faster speed than when all image data are extracted.

The distortion correcting unit 122 divides the image data block B (that is extracted from the image data extracting unit 121 and then stored in the second memory M2) into sub blocks b1 and b2. Then, distortion is corrected. FIGS. 5B and 5C are views illustrating a distortion correcting operation of the exemplary distortion correction unit 122.

Referring to FIG. 5B, the distortion correction unit 122 divides the image data block B into more than one sub block (for example, sub blocks b1 and b2). For example, if the tile size X of the image data block B of FIG. 5B is 256 pixels and the line buffer size Y is 38 lines, the image data block B is divided such that a tile size X1 of a sub block b1 and a tile size X2 of a sub block b2 are 128 pixels, respectively, and then the distortion correction is performed. However, a form where the image data block B is divided into the sub block and the number of sub blocks is not limited to the one described above.

Referring to FIG. 5C, since there is image data that needs to be corrected in the sub block b1 and the sub block b2 among sub blocks, distortion correction is performed by obtaining a pixel coordinate corresponding to an image to be corrected. In various methods for correcting image distortion, a distortion coefficient for image data is extracted first and then distortion of the image data is corrected using the distortion coefficient. In more detail, in order to correct image distortion, the distortion coefficient is extracted through a warping equation or a lens distortion model equation and then, image warping is performed with the distortion coefficient to directly obtain a pixel coordinate corresponding to an image to be corrected. However, a method of correcting distortion is not limited to the one described above and distortion correction may be realized with various well-known methods.

The output image generating unit 123 combines image data to which distortion correction is completed in the distortion correcting unit 122, and then generates an output image for outputting the output image to the display unit 160. For example, by combining a plurality of pieces of image data of which the distortion is corrected with reference to a coordinate value of image data, an output image is generated.

FIG. 6 is a view illustrating a method of extracting image data from an input image according to an embodiment.

According to the embodiment, distortion correction is performed on an entire portion having distortion in an input image signal. Especially, in a case of an input image through a fish-eye lens or a wide lends, distortion occurs largely in a portion corresponding to the outer edge of the lens, compared to the center of the lens. In this case, a large amount of information is in the portion of a high distortion ratio. According to an embodiment, by extracting image data of the distorted portion with a special format, distortion is corrected at a fast speed.

A plurality of image data blocks, namely, first through third image data blocks B1, B2, B3, . . . are extracted from an input image signal. Referring to FIG. 6, the first image data block B1 and the second image data block B2 are disposed adjacent to each other in a row direction (an x-axis direction). In addition, the second image data block B2 and the third image data block B3 are disposed adjacent to each other in the row direction (the x-axis direction). However, the invention is not limited to the arrangement of the image data blocks shown in FIG. 6 and thus, for example, the first image data block B1 and the second image data block B2 may be adjacently disposed in the column direction (the y-axis direction).

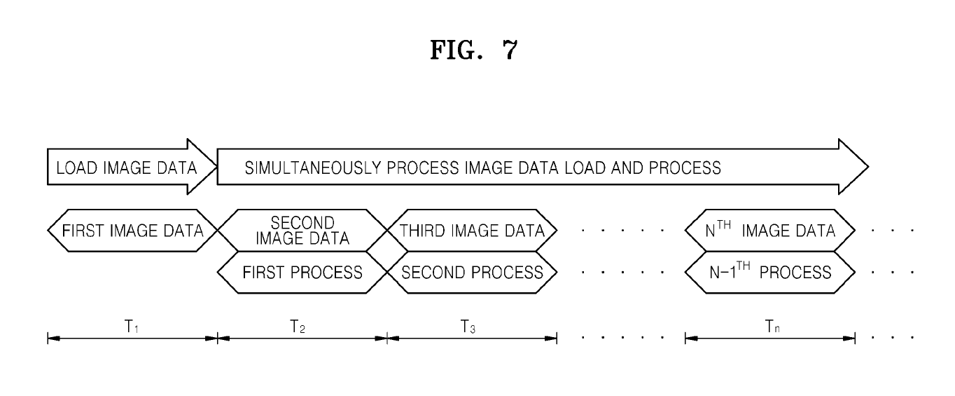

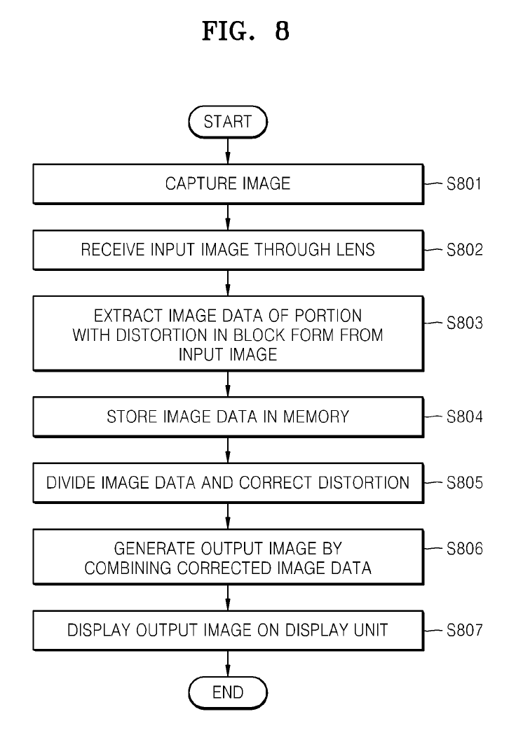

FIG. 7 is a view illustrating a method of correcting image distortion, according to an embodiment.

According to the embodiment, a plurality of image data blocks are extracted from an input image through a lens, and extraction and distortion corrections of image data are continuously performed. Referring to FIG. 7, the image data extracting unit 121 extracts first image data during a period T1, performs distortion correction of the first image data during a period T2, and extracts second image data from the input image during the performing of the distortion correction during the period T2 (a first process). In addition, the image data extracting unit 121 extracts third image data while distortion correction of the second image data is performed (a second process) during a period T3. Through this method, nth image data is extracted during a period Tn and also distortion correction of the n−1 image data is performed (an n−1^{th} process) simultaneously. In this manner, since image data is loaded into the second memory M2 and a process for distortion correction is performed simultaneously, image distortion is processed at a faster speed than when loading of image data and distortion correction are not performed simultaneously.

FIG. 8 is a flowchart illustrating a method of correcting image distortion, according to an embodiment.

Referring to FIG. 8, a user captures an image of a subject by pressing a shutter release button in a capturing mode, in operation S801.

Light from a subject passes through a lens and then is recorded in the image capturing device 112, and an optical signal is converted into an electric signal in the image capturing device 112. Then, the electric signal as an image signal is input to the image signal processor 120. At this point, the image signal may be stored in the first memory M1 of the image signal processor 120, in operation S802. However, the input image signal has distortion due to the lens and thus correction of the input image signal is required.

The image signal processor 120 extracts an image data block B of a portion with distortion from the input image signal, in operation S803. At this point, the image data block B refers to a block including the tile size X in the row direction and the line buffer size Y in the column direction, and image data such as pixels in the image data block B needs to be corrected. The extracted image data block B may be temporarily stored in the second memory M2 of the image signal processor 120.

The image signal processor 120 corrects the distortion of image data stored in the second memory M2. At this point, image data is divided and distortion of the image data is corrected, in operation S805. In more detail, an image data block may be divided into a plurality of sub blocks. For example, if a tile size X of the image data block B stored in the second memory M2 is 256 pixels, the image data block B may be divided into sub blocks b1 and b2 of 128 pixels each and thus image distortion may be corrected with respect to each of the sub blocks b1 and b2. In this manner, when distortion correction is performed by dividing an image data block into sub blocks, distortion correction is performed at a fast speed because repetitive accessing to the first memory M1 is not necessary.

Next, an output image is generated by combining distortion-corrected image data, in operation S806. According to another embodiment, a plurality of image data blocks are extracted from an input image and then the distortion of the plurality of image data blocks is corrected. In addition, the corrected image data blocks are combined. Thus, an output image is generated. Especially, as shown in FIG. 7, since the extracting of the image and the correcting of the extracted image data are simultaneously performed, distortion of the image is corrected at a fast speed and an output image is generated.

Lastly, the output image is displayed on the display unit 160 through the display driving unit 161, in operation S807. However, the invention is not limited thereto. That is, the output image may be temporarily stored in the memory unit 130, output to the display driving unit 161, and then converted into an analog signal. Therefore, the output image may be viewed by a user as a predetermined image.

According to various embodiments, by improving a method of extracting image data from an input image where image distortion occurs due to a lens, the image distortion can be corrected at a fast speed and a corrected image with minimum distortion can be obtained.

Embodiments may include software modules which may be recorded and stored as program instructions or computer readable codes executable by a processor on non-transitory computer readable storage media such as read-only memory (ROM), random-access memory (RAM), CD-ROMs, magnetic tapes, floppy disks, and optical data storage devices. The computer readable storage medium includes any data storage device that can store data which can be thereafter read by a computer system. The computer readable storage medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Descriptions of features or aspects within each embodiment should typically be considered as available for other similar features or aspects in other embodiments.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Functional programs, codes, and code segments for accomplishing the invention can be easily construed by programmers skilled in the art to which the invention pertains.

Furthermore, the invention could employ any number of conventional techniques for electronics configuration, signal processing and/or control, data processing and the like. The words “mechanism”, “component”, “means”, “configuration”, and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. It will be recognized that the terms “comprising,” “including,” and “having,” as used herein, are specifically intended to be read as open-ended terms of art. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

While the present invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method of correcting image distortion in a digital photographing apparatus, the method comprising:
receiving an image signal through a lens;
extracting image data having distortion in a block form from the received image signal;
correcting the distortion by dividing the extracted image data; and
generating and displaying an output image by combining the corrected image data.

2. The method of claim 1, wherein the image data has a block form comprising a tile size X in a row direction and a line buffer size Y in a column direction.

3. The method of claim 2, wherein the image data determines starting address coordinate values of a portion having the distortion, the portion having the distortion determined as a block comprising the tile size X in the row direction and the line buffer size Y in the column direction through the starting address coordinate values.

4. The method of claim 2, wherein, when the tile size X of the image data is 64 pixels, the line buffer size Y is 12 lines.

5. The method of claim 2, wherein, when the tile size X of the image data is 128 pixels, the line buffer size Y is 21 lines.

6. The method of claim 2, wherein, when the tile size X of the image data is 256 pixels, the line buffer size Y is 38 lines.

7. The method of claim 2, wherein, when the tile size X of the image data is 512 pixels, the line buffer size Y is 70 lines.

8. The method of claim 1, further comprising:
storing the image signal from the lens in a first memory; and
extracting the image data in a block form and temporarily storing the extracted image data in a second memory.

9. The method of claim 8, further comprising correcting distortion by dividing the image data stored in the second memory into more than one sub block.

10. A method of correcting image distortion in a digital photographing apparatus, the method comprising:
receiving an image signal through a lens;
extracting first image data of a portion having distortion in a block form from the image signal and loading the extracted first image data into a temporary memory;
extracting second image data adjacent to the first image data in a block form and loading the extracted second image data into a temporary memory while the distortion of the first image data is corrected by dividing the loaded first image data;
correcting distortion of the second image data by dividing the second image data; and
generating and displaying an output image by combining the corrected image data.

11. The method of claim 10, wherein the image data has a block form comprising a tile size X in a row direction and a line buffer size Y in a column direction.

12. The method of claim 10, further comprising correcting the distortion by dividing the loaded image data into more than one sub block.

13. The method of claim 10, further comprising storing the image signal from the lens in a memory.

14. A digital photographing apparatus comprising:
a lens that receives an image signal;
an image signal processor that extracts image data of a portion having distortion in a block form from the image signal, loads the extracted image data in a temporary memory, corrects the distortion by dividing the loaded image data, and generates an output image by combining the corrected image data; and
a display unit that displays the output image.

15. The device of claim 14, wherein the image signal processor comprises:
an image data extracting unit that extracts image data of a portion having distortion in a block form and loads the extracted image data into a temporary memory;
a distortion correcting unit that corrects the distortion by dividing the loaded image data; and
an output image generating unit that generates an output image by combining the corrected image data.

16. The device of claim 14, wherein the image data has a block form comprising a tile size X in a row direction and a line buffer size Y in a column direction.
